(19) United States
(12) Patent Application Publication
(10) Pub. No.: US 2010/0092024 A1
(43) Pub. Date: Apr. 15, 2010

(54) SPEAKER DEVICE

(75) Inventor: Teruaki Kaiya, Tendo-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: PIONEER CORPORATION, Tokyo (JP); TOHOKU PIONEER CORPORATION, Tendo, Yamagata (JP)

(21) Appl. No.: 12/306,455

(22) PCT Filed: Jul. 6, 2006
(86) PCT No.: PCT/JP2006/313475

§ 371 Date: Dec. 23, 2008

(51) Int. Cl. H04R 9/06

(52) U.S. Cl. 381/409

(57) ABSTRACT

A drive cone 11 and a diaphragm 14 are integrally driven by a voice coil 6 which is movably disposed in a magnetic gap 5. Peripheral edges of the drive cone 11 and diaphragm 14 are supported by a frame 12 through edge portions 13 and 15.

A lead wire 21 supplies a drive signal to the voice coil 6. The lead wire 21 is disposed along a surface shape of the edge portion 13 which supports the drive cone 11. The lead wire 21 is mounted along a roll shape of a flexible adhesive utilizing the adhesive.

With this structure, the lead wire 21 deforms such as to follow deformation of the edge portion 13 in the drive cone 11 in accordance with vibration of the diaphragm 14. Therefore, it is possible to prevent a bending stress caused by vibration from being transmitted to a portion of the lead wire.

### TECHNICAL FIELD

The present invention relates to a dynamic type speaker device, and more particularly, to an improvement of a layout structure of an electric supply line (lead wire) for supplying a drive signal to a voice coil.

### BACKGROUND TECHNIQUE

In the dynamic type speaker, basically, a bobbin around which a voice coil is wound is mounted in an inner periphery of a cone type diaphragm, an outer periphery and the inner periphery of the diaphragm are mounted on a frame through an edge portion and a damper, respectively. That is, the edge portion and the damper constitute a suspension of a vibration system.

In a deep bass reproducing speaker so-called woofer or sub woofer utilized in a vehicular audio system, for example, since a diameter of the diaphragm is limited, an amplitude stroke of the diaphragm is increased so that a sufficient sound pressure level of bass can be secured.

The damper which constitutes the suspension of the vibration system must have a function for securing the same amplitude stroke as that of the edge portion without bringing the voice coil into contact with a pole piece and a yoke which constitute a magnetic gap.

Therefore, it is difficult to provide the damper with high compliance, and in a damper of the speaker which secures a large amplitude stroke, there is a problem that nonlinearity of a movable load is brought about and power linearity is deteriorated. In addition, there is also a problem that mechanical fatigue of the damper is generated faster than that of the edge portion.

As the damper, a corrugation damper having a corrugated cross section is frequently used to secure the compliance thereof, but since adjacent corrugated portions are deformed due to the amplitude motion, there is a problem that unusual vibration or scratchy sound is generated. This problem appears seriously in a speaker having increased amplitude stroke of the diaphragm.

The present applicant has already filed an application for a speaker device in which a roll-type edge having the same function as that of the edge portion is employed instead of the damper, and rigidity in the vibration direction of the diaphragm can be enhanced. This application has been disclosed in a laid-open publication shown as Patent Document 1.

According to a structure of the speaker shown in Patent Document 1, it is possible to solve the problem caused when the damper is used, and to enhance the rigidity in the vibration direction of the diaphragm and thus, excellent acoustic characteristics can be obtained as a bass reproducing speaker.

Patent document 1: Japanese Patent Application Laid-open No. 2005-191746.

### DISCLOSURE OF THE INVENTION

### Problem to be Solved by the Invention

In a bass reproducing speaker as shown in Patent Document 1, since the drive signal is supplied to the voice coil, the lead wire must follow a large vibration stroke of the diaphragm, and there is employed such a structure for a lead wire that electricity is supplied from an electric supply terminal disposed on the side of a speaker frame to the voice coil through midair.

In this case, a structure in which the lead wire through midair from the electric supply terminal is connected to a portion of the diaphragm, and the lead wire is connected to the voice coil along the diaphragm, or a structure in which the lead wire is mechanically coupled directly to a voice coil bobbin from the electric supply terminal through midair may be employed.

A portion of the lead wire which floats in the air is styled into a specific shape while having enough length, but when the lead wire receives great amplitude from the diaphragm, the styled shape can not be held and is deformed or that portion is fallen. With this, a portion of the lead wire which comes into contact with the electric supply terminal or a portion of the lead wire which comes into contact with the vibration system (root portion) receives a great bending stress. Therefore, if the bending motion of the lead wire is repeated when the diaphragm vibrates, there is a problem that the root portion of the lead wire is cut.

The present invention has been accomplished in view of the problem of the lead wire which goes by way of midair, and it is an object of the present invention to provide a speaker device which can suitably be employed for a speaker having a cone type diaphragm and a drive cone which supports a back surface of the diaphragm, and which does not impart the bending stress to a specific portion of the lead wire.

### Means for Solving the Problem

To solve the above problem, as described in claim 1, a preferable speaker device according to the present invention comprises a diaphragm and a drive cone driven by a voice coil which is movably disposed in a magnetic gap, in which outer peripheral edges of the drive cone and the diaphragm are supported on a frame through different edge portions, and a lead wire which supplies a drive signal to the voice coil is disposed along a surface shape of the edge portion which support the drive cone.

To solve the above problem, as described in claim 8, a preferable speaker device according to the invention comprises a diaphragm and a drive cone driven by a voice coil which is movably disposed in a magnetic gap, in which outer peripheral edges of the drive cone and the diaphragm are supported on a frame through different edge portions, a lead wire which supplies a drive signal to the voice coil penetrates the edge portion which supports the drive cone and with this, the lead wire is supported in the edge portion.

### Effect of the Invention

According to the former speaker device, since the lead wire which supplies a drive signal to the voice coil is disposed along the surface shape of the edge portion which supports the drive cone which is integrally driven with the diaphragm. Therefore, the lead wire is deformed such as to follow the deformation of the edge portion of the drive cone in accordance with vibration of the diaphragm.

That is, since the lead wire follows the deformation of the edge portion which supports the drive cone, like the conventional structure in which the portion of the lead wire floats in the air, the lead wire freely deforms as it is vibrated, and a degree of the root portion on which the lead wire is mounted which receives a large bending stress can remarkably be reduced.

According to the latter speaker device, the lead wire which supplies a drive signal to the voice coil passes through the edge portion which supports the drive cone which is integrally driven with the diaphragm, thereby supporting the lead wire at the edge portion. Therefore, like the conventional structure in which a portion of the lead wire floats in the air, it is possible to prevent the lead wire from freely deforming as it is vibrated.

Therefore it is possible to effectively avoid the problem that the root portion on which the lead wire is mounted locally receives a bending stress and the lead wire is cut like the conventional structure.

### BRIEF DESCRIPTION OF THE DRAWINGS

FIG. 1 is a partial sectional view showing a first embodiment of a speaker device according to the present invention;

FIG. 2 are plan views and partial sectional views showing layout of a lead wire which is suitably employed in the speaker device shown in FIG. 1;

FIG. 3 are plan views and partial sectional views showing preferable another layout of the lead wire;

FIG. 4 is a partial sectional view of a second embodiment of the speaker device of the invention;

FIG. 5 is a partial sectional view showing a third embodiment;

FIG. 6 is a partial sectional view showing a fourth embodiment; and

FIG. 7 is a partial sectional view showing a fifth embodiment.

### EXPLANATION OF REFERENCE NUMERALS

1 pole yoke
2 magnet
3 plate
4 sub plate
5 magnetic gap
6 voice coil
7 coil bobbin
11 drive cone
12 frame
13 edge portion
14 diaphragm
15 edge portion
16 gasket
17 center cap
21 lead wire
22 relay terminal
23 supply terminal
25 thread
A hermetic space

### BEST MODE FOR CARRYING OUT THE INVENTION

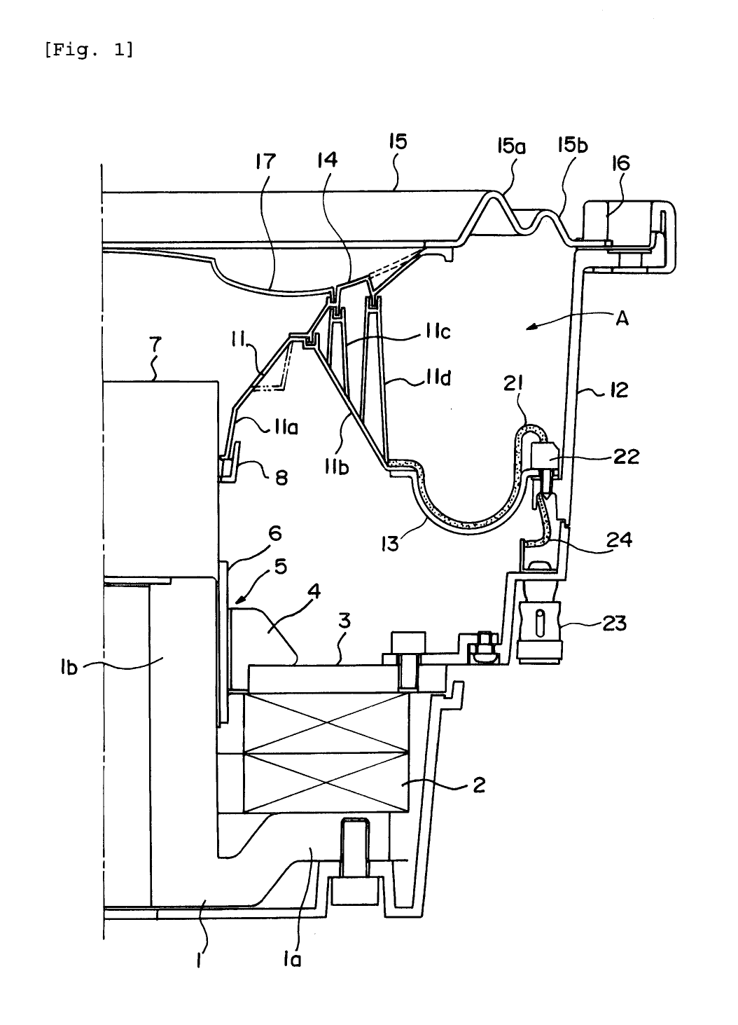

A speaker device according to the present invention will be explained based on embodiments illustrated in the drawings. FIG. 1 shows the first embodiment, and is a sectional view of a right half of the speaker device from its center line. A reference numeral 1 represents a pole yoke whose center portion is a hollow. A disk-like flange 1a is integrally formed on a bottom of the pole yoke 1, ring-like magnets 2 are mounted on the flange 1a coaxially with a cylindrical portion 1b of the pole yoke 1.

A ring plate 3 is mounted on an upper surface of the magnet 2, and a ring sub plate 4 is mounted such that it is fitted to the inner peripheral surface of the plate 3. With this structure, a magnetic gap 5 is formed between the inner peripheral surface of the ring sub plate 4 and the outer peripheral surface of the pole yoke 1 (outer peripheral surface of the cylindrical portion 1b).

A cylindrical coil bobbin 7 around which a voice coil 6 is wound is mounted in the magnetic gap 5 such that the coil bobbin 7 can move along a longitudinal direction (vertical direction in the drawing) of the pole yoke 1. A ring member 8 is mounted on the outer peripheral surface of the coil bobbin 7 near its upper end. To form a U-shaped adhesive reservoir between the ring member 8 and the coil bobbin 7, a wall surface of the ring member 8 is formed upward, thereby forming an L-shaped cross section.

The inner peripheral end of the drive cone 11 enters a U-shaped portion formed between the ring member 8 and the coil bobbin 7, and the inner peripheral end of the drive cone 11 is coupled to the outer peripheral surface of the coil bobbin 7 by adhesive (not shown) poured into the U-shaped portion. For example, the drive cone 11 is formed of synthetic resin material into substantially a cylindrical shape as a whole. The drive cone 11 is formed with a rising portion 11a rising from the inner peripheral edge of the drive cone 11 in the direction of the normal (outer peripheral direction) at an acute angle, and a falling portion 11b falling in the direction of the normal outside thereof.

Ribs 11c and 11d are coaxially integrally formed on an upper surface of the falling portion 11b of the drive cone 11 inside and outside of the falling portion lib in the acoustic radiation axial direction. In this embodiment, one of them formed inside is called an inner rib 11c, and the other formed outside is called outer a rib 11d.

The outermost edge of the drive cone 11 is formed into a flange. A roll-like edge portion 13 is interposed between the flange and a frame 12. That is, the drive cone 11 is supported by the frame 12 through the roll-like edge portion 13 such that the drive cone 11 can reciprocate in the acoustic radiation axial direction.

An annular groove is formed in each of an annular top of the drive cone 11 formed by the rising portion 11a, and each of annular tops of the inner rib 11c and the outer rib 11d along the tops. The diaphragm 14 is mounted on a front surface of the drive cone 11 by adhesive (not shown) poured into each of the grooves.

That is, annular convex portions which enter the grooves are formed in the back surface of the diaphragm 14. With this structure, the diaphragm 14 is driven integrally with the drive cone through the drive cone 11. The outer peripheral edge of the diaphragm 14 is supported by an open edge of the frame 12 through an angle edge portion 15. A reference numeral 16 represents a gasket which nips an outer peripheral edge of the edge portion 15 in the open edge of the frame 12.

The diaphragm 14 shown in this embodiment is formed into an annular shape such as to occupy an outer region of the speaker diameter. A center cap 17 which occupies a relatively large area is mounted on an inner diameter portion of the diaphragm 14. That is, the outer peripheral edge of the center cap 17 is folded toward its back surface side, the outer peripheral edge enters the groove formed in the diaphragm 14. And the center cap 17 is mounted on the diaphragm 14 by adhesive (not shown) in the groove.

The diaphragm 14 is mounted on the annular groove formed in the inner rib 11c of the drive cone 11 at a position directly below (on the side of the back surface) of the diaphragm 14 on which the outer peripheral edge of the center cap 17 is mounted. With this, the center cap 17 reciprocates and vibrates in the acoustic radiation axial direction together with the diaphragm 14 located on its outer periphery. With this, sufficient bass sound pressure level can be secured.

In the outer peripheral edge of the diaphragm 14, an angle edge portion 15 supports the diaphragm 14 such that the diaphragm 14 can vibrate. The edge portion 15 includes a first region 15a which is high on the side of its inner side and which is wide in width, and a second region 15b which is high on the side of its outer side and which is narrow in width. With this structure, the edge portion which constitutes the first region 15a can secure large compliance, and the edge portion can excellently follow the driving of large amplitude of the diaphragm 14.

In the speaker device having the above-described structure, it is desirable that a space A surrounded by the edge portion 15, the diaphragm 14, the drive cone 11, the edge portion 13 and the frame 12 is hermetically formed. Gas in the hermetical space A functions as an air spring, and the diaphragm 14 which goes by way of the drive cone 11 functions such as to be driven integrally with the drive cone.

In the speaker device of above-described structure, the lead wire which supplies the drive signal to the voice coil 6 is held utilizing the edge portion 13 which supports the drive cone 11. That is, in the structure shown in FIG. 1, the lead wire 21 is disposed along the surface shape (roll shape) of the edge portion 13 in the hermetic space A in the edge portion 13.

In the embodiment shown in FIG. 1, one end of the lead wire 21 is connected to a relay terminal 22 disposed in a portion of the frame 12. A connecting line 24 is connected between the terminal 22 and a supply terminal 23 which is mounted on the frame 12 such that the supply terminal 23 is directed outward. A speaker driving electric signal is supplied to the relay terminal 22 through the connecting line 24.

The other end of the lead wire 21 is connected to the voice coil 6 through the drive cone 11 (this situation is not illustrated in the drawing). The lead wire 21 is mounted on the edge portion 13 through adhesive (not shown) having flexibility such that the lead wire 21 extends along the roll shape. The edge portion 13 supports the drive cone.

The lead wire 21 deforms such as to follow the deformation of the edge portion 13 in the drive cone 11 which follows the vibration of the diaphragm 14. According to this structure, like the conventional structure in which the lead wire floats in the air, the lead wire freely deforms with vibration, and a degree that the root portion on which the lead wire is mounted receives great bending stress can remarkably be reduced.

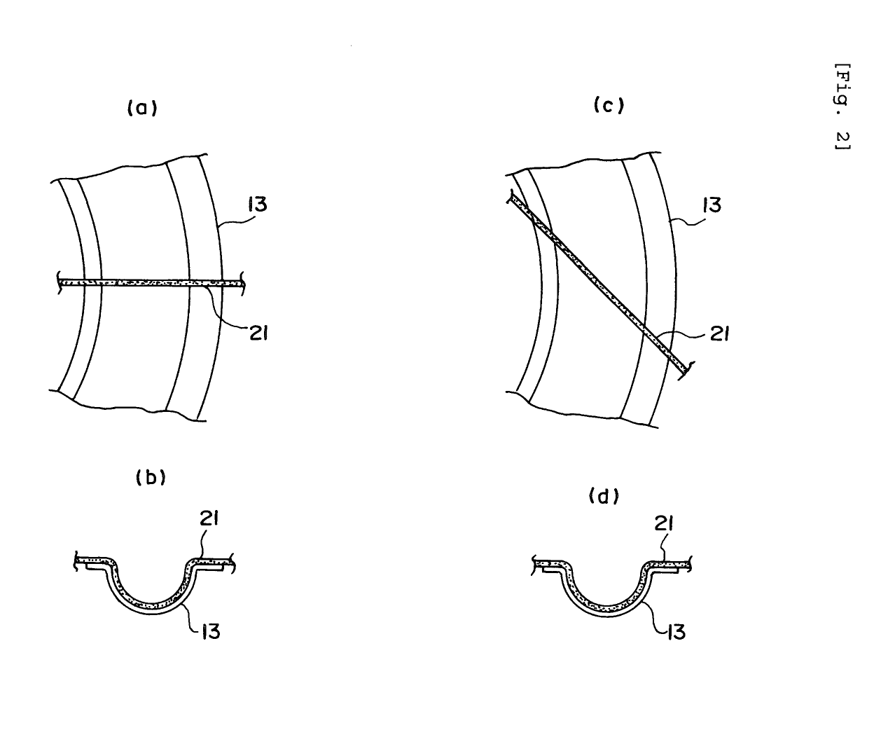

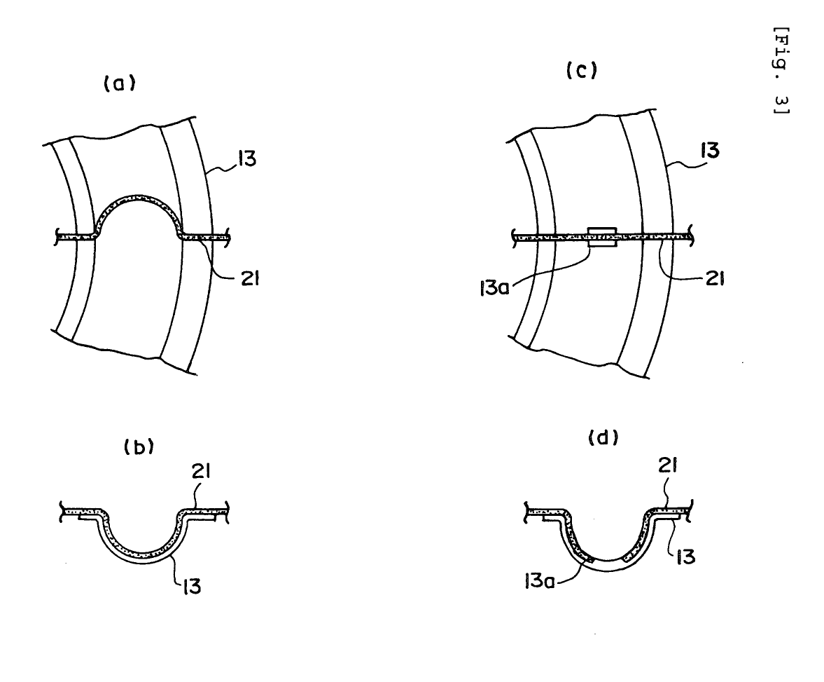

FIGS. 2 and 3 show styling modes of the lead wire 21 disposed along the surface shape of the edge portion 13 which supports the drive cone. FIGS. 2(a) and (b) show a first example, (a) shows a layout state of the lead wire 21 in which the edge portion 13 is viewed from above, and (b) shows a layout state of the lead wire 21 as viewed from a direction of an end surface of a state where the edge portion 13 is cut in the direction of the normal. In the first example, the lead wire 21 is disposed along the roll shape of the edge portion and along the direction of the normal.

FIGS. 2(c) and (d) show a second example, (c) shows a layout state of the lead wire 21 in which the edge portion 13 is viewed from above, and (d) shows a layout state of the lead wire 21 as viewed from a direction of an end surface of a state where the edge portion 13 is cut in the direction of the normal. In the second example, the lead wire 21 is disposed along the roll shape of the edge portion such as to cut across the direction of the normal at an acute angle.

FIGS. 3(a) and (b) show a third example thereof, (a) shows a layout state of the lead wire 21 in which the edge portion 13 is viewed from above, and (b) shows a layout state of the lead wire 21 as viewed from a direction of an end surface of a state where the edge portion 13 is cut in the direction of the normal. In the third example, the lead wire 21 is disposed along the roll shape of the edge portion such as to draw an arc in the normal direction.

FIGS. 3(c) and (d) show a forth example thereof, (c) shows a layout state of the lead wire 21 in which the edge portion 13 is viewed from above, and (d) shows a layout state of the lead wire 21 as viewed from a direction of an end surface of a state where the edge portion 13 is cut in the normal direction. In the fourth embodiment, a groove 13a in which a portion of the lead wire 21 can be accommodated is formed in the edge portion 13 in the direction of the normal. A portion of the lead wire 21 extending along the roll shape of the edge portion is accommodated in the groove 13a.

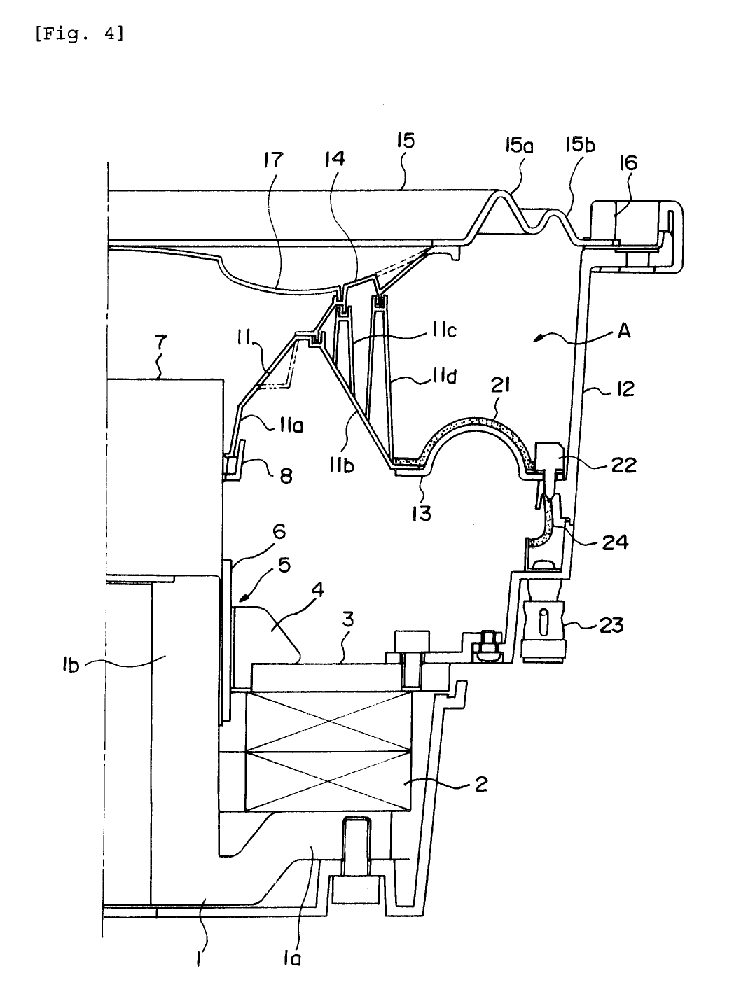

FIG. 4 shows a second embodiment of the speaker device of the present invention. Like FIG. 1, FIG. 4 is a sectional view of a right half from the center line of the speaker device. The basic structure of the speaker shown in FIG. 4 is the same as that of the already explained speaker shown in FIG. 1, the corresponding parts are designated with the same reference numerals, and detailed explanation thereof will be omitted.

The structure of the speaker shown in FIG. 4 is different from that shown in FIG. 1 in that the roll shape of the edge portion 13 which supports the peripheral edge of the drive cone 11 is curved upward, i.e., toward the hermetic space A. In the edge portion 13 having the upper roll shape as shown in FIG. 4, the layout states of the lead wire 21 as shown in FIGS. 2 and 3 can also appropriately be employed.

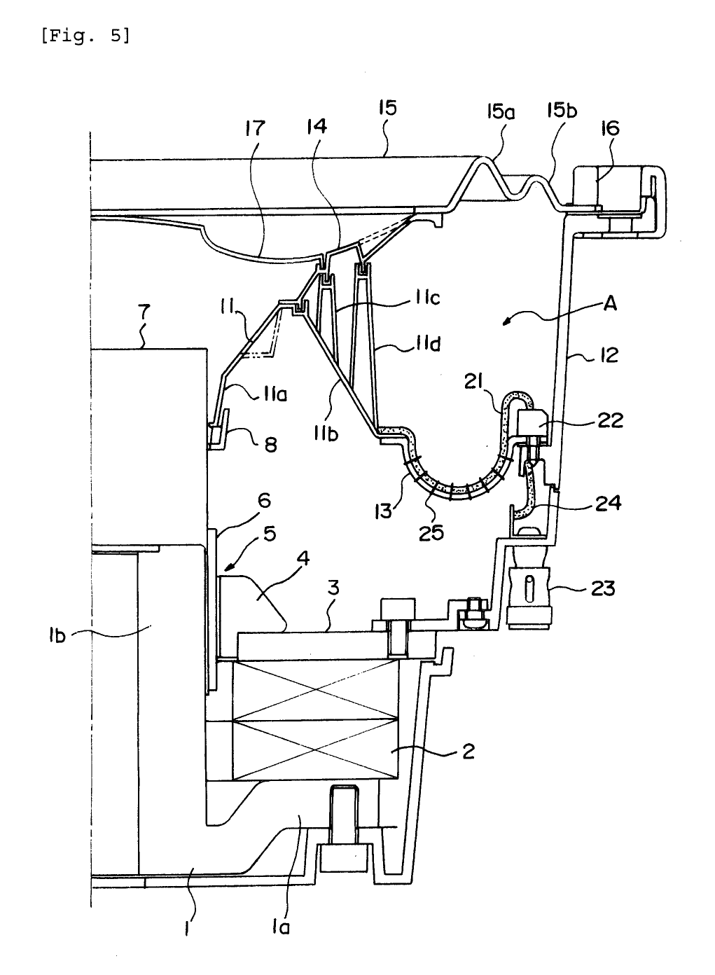

FIG. 5 shows a third embodiment of the speaker device of the present invention. Like FIG. 1, FIG. 5 is a sectional view of a right half from the center line of the speaker device. The basic structure of the speaker shown in FIG. 5 is the same as that of the already explained speaker shown in FIG. 1, the corresponding parts are designated with the same reference numerals, and detailed explanation thereof will be omitted.

The structure of the speaker shown in FIG. 5 is different from that shown in FIG. 1 in that the lead wire 21 disposed along the surface shape of the edge portion 13 which supports the periphery of the drive cone 11 is fixed by a thread 25. In this case, if the adhesive is applied to a penetrating portion of the thread 25 through the edge portion 13 as need arises, the hermetic space A can be secured.

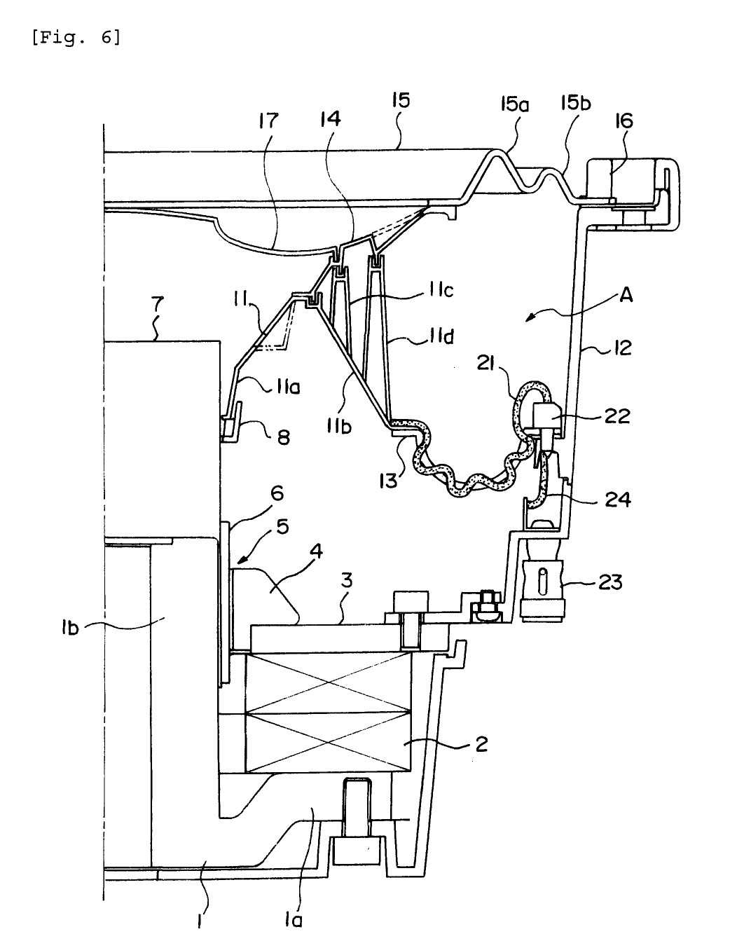

FIG. 6 shows a fourth embodiment of the speaker device of the present invention. Like FIG. 1, FIG. 6 is a sectional view of a right half from the center line of the speaker device. The basic structure of the speaker shown in FIG. 6 is the same as that of the already explained speaker shown in FIG. 1, the corresponding parts are designated with the same reference numerals, and detailed explanation thereof will be omitted.

The structure of the speaker shown in FIG. 6 is different from that shown in FIG. 1 in that in the edge portion 13 which supports the peripheral edge of the drive cone 11, the lead wire 21 is sewed and fixed to the edge portion in a corrugated manner. In this case, if the adhesive is applied to a penetrating portion of the lead wire 21 through the edge portion 13 as need arises, the hermetic space A can be secured.

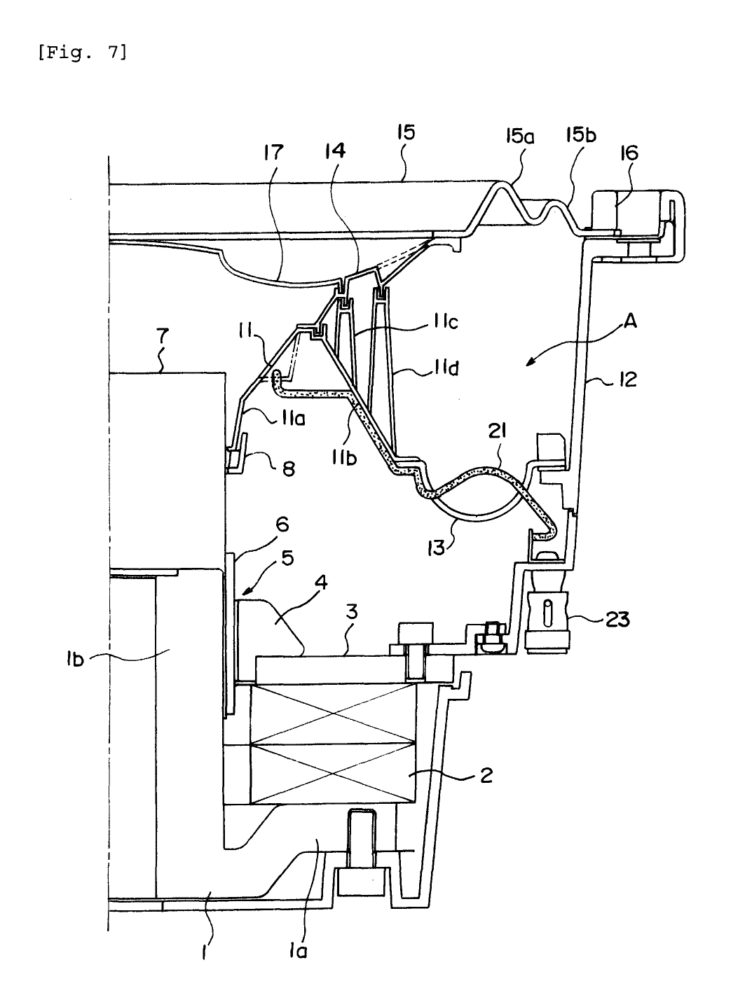

FIG. 7 shows a fifth embodiment of the speaker device of the present invention. Like FIG. 1, FIG. 7 is a sectional view of a right half from the center line of the speaker device. The basic structure of the speaker shown in FIG. 7 is the same as that of the already explained speaker shown in FIG. 1, the corresponding parts are designated with the same reference numerals, and detailed explanation thereof will be omitted.

The structure of the speaker shown in FIG. 7 is different from that shown in FIG. 1 in that in the lead wire 21 which supplies the drive signal to the voice coil 6 penetrates the edge portion 13 which supports the drive cone 11 at two locations and with this, the lead wire 21 is supported by the edge portion 13.

According to this structure, the lead wire 21 penetrates the edge portion 13 and the lead wire is supported in the edge portion. Therefore, it is possible to prevent the lead wire, like the conventional structure in which a portion of the lead wire floats in the air, from freely deforming with vibration. Therefore, it is possible to effectively solve the problem that the lead wire receives a bending stress caused with vibration at a root portion on which the lead wire and the lead wire is cut.

1-9. (canceled)

10. A speaker device comprising a drive cone driven by a voice coil which is movably disposed in a magnetic gap, and a diaphragm which receives a driving force from the voice coil through the drive cone and which is integrally driven with the drive cone, in which an outer peripheral edge of the drive cone is supported by a frame through a first edge portion, an outer peripheral edge of the diaphragm is supported by the frame through a second edge portion which is different from the first edge portion, the speaker device characterized in that:
a lead wire supplies a drive signal to the voice coil, the lead wire extends along a connection between the drive cone and the first edge portion, the lead wire also extends along a surface shape of the first edge portion, and the lead wire is disposed along a connection between the first edge portion and the frame.

11. The speaker device according to claim 10, the speaker device characterized in that: the lead wire is disposed along a direction of the normal of the annularly formed drive cone.

12. The speaker device according to claim 10, the speaker characterized in that: the lead wire cuts across the direction of the normal of the annularly formed drive cone at an acute angle.

13. The speaker device according to claim 10, the speaker characterized in that: the lead wire is disposed such as to draw an arc with respect to the direction of the normal of the annularly formed drive cone.

14. The speaker device according to claim 10, the speaker characterized in that: the edge portion which supports the drive cone is formed with a groove in which a portion of the lead wire can be accommodated.

15. The speaker device according to claim 10, the speaker characterized in that: on the edge portion which supports the drive cone, the lead wire is fixed by means of a thread.

16. The speaker device according to claim 10, the speaker characterized in that: on the edge portion which supports the drive cone, the lead wire is sewed and fixed to the edge portion.

17. A speaker device comprising a drive cone driven by a voice coil which is movably disposed in a magnetic gap, and a diaphragm which receives a driving force from the voice coil through the drive cone and which is integrally driven with the drive cone, in which an outer peripheral edge of the drive cone is supported by a frame through a first edge portion, an outer peripheral edge of the diaphragm is supported by the frame through a second edge portion which is different from the first edge portion, the speaker device characterized in that:
a lead wire supplies a drive signal to the voice coil, the lead wire is supported by the first edge portion in a state where the lead wire penetrates the first edge portion, and the lead wire is disposed along the drive cone.

18. The speaker device according to claim 10, the speaker characterized in that: a space surrounded by the drive cone, the frame and the diaphragm forms a hermetic space.
